(19) United States
(12) Patent Application Publication
(10) Pub. No.: US 2008/0144643 A1
(43) Pub. Date: Jun. 19, 2008

(54) Mesh network

(75) Inventor: Heikki Berg, Viiala (FI)

Correspondence Address: SQUIRE, SANDERS & DEMPSEY L.L.P., 8000 TOWERS CRESCENT DRIVE, 14TH FLOOR, VIENNA, VA, 22182-2700, US

(73) Assignee: Nokia Corporation

(21) Appl. No.: 11/712,915

(22) Filed: Mar. 2, 2007

(30) Foreign Application Priority Data
Dec. 15, 2006 (FI) 20065811

(51) Int. Cl. H04L 12/28

(52) U.S. Cl. 370/401; 370/465

(57) ABSTRACT

There is provided a method comprising: providing two transmission bands for simultaneous communication of signals by a plurality of mesh nodes of a mesh network; dividing both of the transmission bands into at least three subchannel regions, each subchannel region including a subset of available logical subchannels of a multiple access technology; and allocating at least four subchannel regions of the transmission bands to each mesh node of the plurality of mesh nodes for use in transmission and reception, wherein the transmission and reception of a mesh node are allocated to subchannel regions of different transmission bands.

### FIELD

The invention relates to a method, to a mesh node, to a mesh network, to a transceiver, and to a computer-readable program distribution medium.

### BACKGROUND

Duplexing designs for future broadband access have recently been studied extensively. A document “Duplex arrangement for future broadband radio interfaces” IST-2003-507581 WINNER D2.5 v1.0 studies different relay duplexing mechanisms. As to mesh and relay use, the above document concentrates on Time Domain Duplexing (TDD) and Half-Duplex Frequency Domain Duplexing (FDD) for the relaying designs.

According to the above document, TDD is advantageous in handling traffic symmetries, in supporting multihop applications, and preferable in case of direct link, i.e. terminal-to-terminal, communications. Moreover, the document relies on transmission on unpaired bands, which may facilitate the search for spectrum for broadband communications. However, TDD requires synchronization and coordination between different operators assigned to adjacent carriers, unless spatial decoupling and/or interference avoidance techniques can guarantee sufficiently low levels of crosslink (uplink-to-downlink and downlink-to-uplink) interference. In this respect, Half Duplex FDD has an advantage over TDD, especially in cellular wide area coverage scenarios. FDD has not been considered for mesh networks because multiple transceivers would be required to transmit and receive simultaneously.

FIG. 1 illustrates a mesh network topology. Access gateways (AG) 122, 124 of an access network 120 have fixed connections to the Internet 130. The access gateways 122, 124 forward traffic from the Internet 130 via wireless relay nodes (RN) 100, 101, 102, 103, 104, 105 to mobile nodes 110, 111, 112, 113, 114, 115.

One of the assumptions in future next generation designs is that an RN-to-RN radio for mesh is different from RN-to-MN client access radios. Reason for this is that the properties of the mesh network ad client access are different. Mesh radios are more “equivalent” with each other and need to manage the radio resources collectively. A client access radio, however, is connected only to a single access point (RN/AG), thus the access point behaves like a traditional base station from the point of view of the mobile node.

In mesh data forwarding, very low delay and low jitter connections between the relay nodes are required. This is needed for applications requiring low delay running over the mesh networks. Further, in mesh networks relay nodes are actively connected to a limited amount of other relay nodes. Usually such a connection is provided only to the nearest relay node, which then forwards the traffic to the next node.

### BRIEF DESCRIPTION OF THE INVENTION

An object of the invention is to provide an improved method, a mesh node, a mesh network, a transceiver, and a computer-readable program distribution medium.

According to an aspect of the invention, there is provided a method comprising: providing two transmission bands for simultaneous communication of signals by a plurality of mesh nodes of a mesh network; dividing both of the transmission bands into at least three subchannel regions, each subchannel region including a subset of available logical subchannels of a multiple access technology; and allocating at least four subchannel regions of the transmission bands to each mesh node of the plurality of mesh nodes for use in transmission and reception, wherein the transmission and reception of a mesh node are allocated to subchannel regions of different transmission bands.

According to another aspect of the invention, there is provided a mesh node comprising: a processing unit for controlling functions of the mesh node; and a transceiver for simultaneous communication of signals with one or more other mesh nodes of a mesh network using two transmission bands, wherein both of the two transmission bands include at least three subchannel regions, each subchannel region including a subset of available logical subchannels of a multiple access technology. The processing unit is configured to control use of at least four subchannel regions allocated to the mesh node for transmission and reception, wherein the transmission and reception of the mesh node are allocated to subchannel regions of different transmission bands.

According to another aspect of the invention, there is provided a mesh network comprising a plurality of mesh nodes according to claim 5.

According to another aspect of the invention, there is provided a transceiver for a mesh node, the transceiver comprising: a transmitter for transmitting signals in at least one subchannel region of at least three subchannel regions of a transmission band of two transmission bands allocated to a plurality of mesh nodes of a mesh network for simultaneous communication of signals, each subchannel region including a subset of available logical subchannels of a multiple access technology; and a receiver for receiving signals in at least one subchannel region of at least three subchannel regions of a transmission band of the two transmission bands other than that the transmitter is using for transmitting. The transceiver is configured to control use of at least four subchannel regions allocated to the mesh node for transmission and reception.

According to another aspect of the invention, there is provided a computer-readable program distribution medium encoding a computer program of instructions for executing a computer process, the process comprising: providing two transmission bands for simultaneous communication of signals by a plurality of mesh nodes of a mesh network; dividing both of the transmission bands into at least three subchannel regions, each subchannel region including a subset of available logical subchannels of a multiple access technology; and allocating at least four subchannel regions of the transmission bands to each mesh node of the plurality of mesh nodes for use in transmission and reception, wherein the transmission and reception of a mesh node are allocated to subchannel regions of different transmission bands.

According to another aspect of the invention, there is provided a mesh node comprising: transceiver means for simultaneous communication of signals with one or more other mesh nodes of a mesh network using two transmission bands, wherein both of the two transmission bands include at least three subchannel regions, each subchannel region including a subset of available logical subchannels of a multiple access technology, and processing means for controlling use of at least four subchannel regions allocated to the mesh node for transmission and reception, wherein the transmission and reception of the mesh node are allocated to subchannel regions of different transmission bands.

According to another aspect of the invention, there is provided a transceiver for a mesh node, the transceiver comprising: transmitting means for transmitting signals in at least one subchannel region of at least three subchannel regions of a transmission band of two transmission bands allocated to a plurality of mesh nodes of a mesh network for simultaneous communication of signals, each subchannel region including a subset of available logical subchannels of a multiple access technology; receiving means for receiving signals in at least one subchannel region of at least three subchannel regions of a transmission band of the two transmission bands other than that the transmitter is using for transmitting; and processing means for controlling use of at least four subchannel regions allocated to the mesh node for transmission and reception.

The invention provides several advantages.

A flexible subchannel reuse mechanism in mesh networks is provided. Frequency division duplexing can now be used in mesh networks. Packet forwarding delays are minimized since all mesh nodes are able to transmit simultaneously. There is no need to use guard times. The whole mesh network can forward traffic simultaneously.

### LIST OF DRAWINGS

In the following, the invention will be described in greater detail with reference to the embodiments and the accompanying drawings, in which

FIG. 1 illustrates an example of a mesh network topology;

FIG. 2 illustrates an example of a mesh node;

FIG. 3 illustrates an example of an OFDM transmitter;

FIG. 4 illustrates an example of a frequency domain characterization of a dual carrier FDD according to an embodiment of the invention; and

FIG. 5 illustrates an example of a method according to an embodiment of the invention.

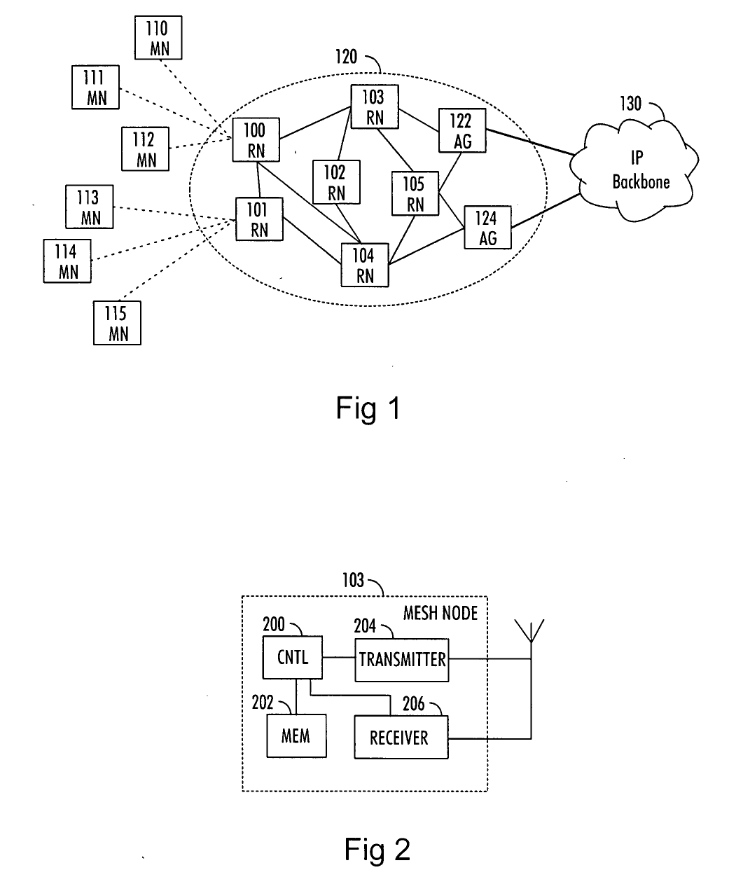

### DESCRIPTION OF EMBODIMENTS

With reference to FIG. 2, examine an example of an electronic device, such as a mesh node of a mesh network, to which embodiments of the invention can be applied. The mesh node 103 comprises a processing unit 200, typically implemented with a microprocessor, a signal processor or separate components and associated software. The device further comprises a transceiver including a transmitter 204 and a receiver 206 for communicating signals with one or more other mesh nodes of the mesh network. The processing unit 200 controls the transmission and reception of data via the transmitter 204 and the receiver 206 and updates a mesh node neighbour list in a memory 202 as neighbour mesh nodes are detected.

In an embodiment, two transmission bands are provided in the mesh network for simultaneous communication of signals by a plurality of mesh nodes of the mesh network. The transmission bands are divided into at least three subchannel regions, each subchannel region including a subset of available logical subchannels of a multiple access technology. At least four subchannel regions of the transmission bands are allocated to each mesh node 103 of the plurality of mesh nodes for use in transmission and reception.

In an embodiment, the transmitter 204 is configured to transmit signals in at least one subchannel region of the at least three subchannel regions allocated to the mesh node. The receiver 206 is configured to receive signals in at least one subchannel region of the at least three subchannel regions of a transmission band of the two transmission bands other than that the transmitter is using for transmitting. The processing unit 200 is configured to control use of at least four subchannel regions allocated to the mesh node for transmission and reception.

In an embodiment, a mesh network with frequency division duplexing is provided by using just two transmission bands (or channels), such that different reuse factors can easily be designed within these bands. This enables subchannelization within a transmission band, together with FDD duplexing, in a mesh network. One mechanism for creating subchannelization within a transmission band is orthogonal frequency division multiple access (OFDMA). In the following embodiments, mesh radios using OFDMA are presented as examples. The same principle can, however, be applied to any radio systems using subchannelization for resource allocation. For example, according to an embodiment where dual carrier FDD frequency reuse concept uses code division multiplexing (CDMA) instead of OFDMA, then the subchannel regions would refer to code regions.

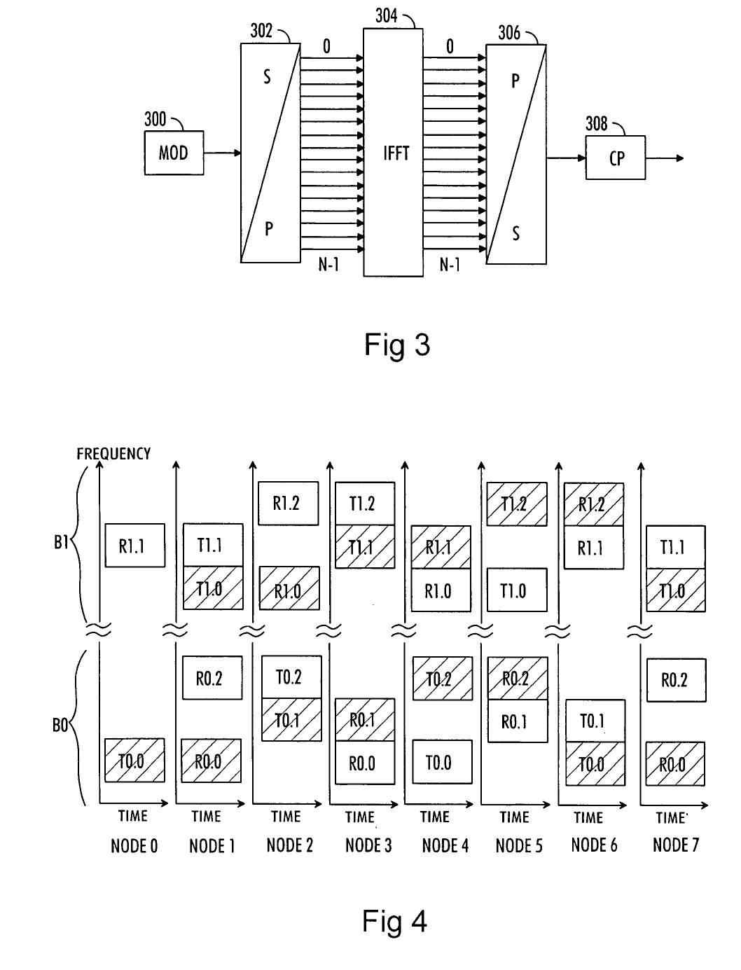

An example of a transmitter is illustrated in FIG. 3. The OFDM signal is directed via a transmitter mod 300, serial-to-parallel conversion 302, inverse fast Fourier transform (IFFT) 304, parallel-to-serial conversion 306, and a cyclic prefix inserted in 308 depends on the output of the IFFT 304. In an OFDM transmitter, the bandwidth of B is separated into N orthogonal subcarriers. In typical implementations, the number of orthogonal subcarriers is a power of 2 (64, 128, 256, . . . , up to 8192), due to simple realization of orthogonal subcarriers through fast Fourier transform (FFT). Selected subcarrier spacing (FFT size) depends on the expected frequency selectivity in a radio channel.

Orthogonal frequency division multiple access (OFDMA) is a mechanism for creating frequency division multiple access (FDMA) by using OFDM. In an OFDMA transmitter, the useful part of the subcarriers 0 to N−1 of an OFDMA signal is divided into a number of K logical subchannels. These subchannels can then be assigned to different users. The subcarriers belonging to a logical subchannel can either be distributed over the whole useful band giving a high amount of frequency diversity or packed together for enabling interference control mechanisms and frequency domain scheduling with low frequency diversity.

FIG. 4 illustrates an example of a frequency domain characterization of a dual carrier FDD according to an embodiment of the invention. A dual carrier FDD frequency reuse concept using OFDMA is illustrated in FIG. 4 for frequency reuse 1/3. FIG. 4 depicts transmit and receive time and frequency allocation for different mesh hops in a same time-frequency grid, i.e. at the same time.

In the example of FIG. 4, the different mesh nodes (or hops) are numbered from 0 to 7. Let us assume that NODE 0 is an access gateway having a fixed Internet connection. Then traffic towards NODE 0 is uplink traffic that is illustrated with boxes without dashed lines. Respectively, the traffic away from NODE 0 is downlink traffic that is illustrated with boxes with dashed lines.

In an embodiment, two transmission bands B0 and B1 are provided for simultaneous communication of signals by the plurality of mesh nodes NODE 0 to NODE 7 of the mesh network. The transmission bands B0 and B1 are divided into at least three subchannel regions (0, 1, 2), each subchannel region including a subset of available logical subchannels of a multiple access technology. Further, at least four subchannel regions, i.e. frequency regions in this OFDMA related example, of the transmission bands are allocated to each mesh node of the plurality of mesh nodes for use in transmission and reception, and the transmission and reception of a mesh node are allocated to subchannel regions of different transmission bands.

Dual carrier FDD requires use of two transmission bands B0 and B1 of bandwidth B separated far enough in duplex frequency for enabling a mesh node to transmit in one channel and to receive in another channel. The use of these transmission bands B0 and B1 for transmission and reception varies from hop to hop.

The two transmission bands B0 and B1 are internally divided into at least three non-overlapping subchannel regions, i.e. frequency regions in this OFDMA example. For simplicity, in FIG. 4 these subchannel regions are depicted to be contiguous frequency regions (0, 1, 2). However, the frequency regions are not required to be contiguous. For example, distributed subchannel mapping can be used to create non-overlapping frequency regions. Each of the subchannel regions (0, 1, 2) includes a subset of available OFDMA logical subchannels. Instead of OFDMA, any multiple access mechanism using orthogonal subchannelization can also be used.

In the example of FIG. 4, data transmitted from a mesh node is depicted with a letter T and data received is depicted with a letter R. The first number after the letter indicates the number of the transmission band B0 or B1, and the second number after the letter indicates the number of the subchannel region 0, 1 or 2 of a transmission band B0 or B1.

In the example of FIG. 4, NODE 0 is transmitting in a transmission band B0 in a subchannel region 0 (T0.0) to NODE 1 which, in turn, is receiving in the respective transmission band and subchannel region (R0.0). At the same time, NODE 1 is receiving data transmitted (T0.2) from NODE 2 in the transmission bc in a subchannel region 2 (R0.2). Further, NODE 1 is transmitting data in a transmission band 1 in subchannel regions 0 and 1 to nodes NODE 0 and NODE 2 (T1.0, T1.1). Respectively, mesh nodes NODE 0 and NODE 2 receive this transmission from NODE 1 in the transmission band B1 and in subchannel regions 0 and 1 (R1.1, R1.0). Respective transmissions between different mesh nodes are illustrated accordingly. In the simplified example of FIG. 4, the mesh nodes are in a chain, i.e. the mesh nodes adjacent to one another are neighboring mesh nodes. However, the structure of the mesh network may vary. For example, the NODE 3 can communicate with mesh nodes NODE 2 and NODE 4, and the NODE 5 can communicate with mesh nodes NODE 4 and NODE 6. The mesh node NODE 7 may transmit (T1.0) and receive (R0.2) data from a further mesh node that is not shown in FIG. 4.

Although in FIG. 4 the capacity allocation for uplink and downlink traffic is depicted to be of equal size, this is not necessary. The mesh nodes can freely balance the downlink and uplink resource allocations according to their needs. When transmission between mesh nodes is omnidirectional, for example, NODE 3 to uplink direction and NODE 5 to downlink direction are able to receive both uplink and downlink transmission of NODE 4.

In FIG. 4, it can be seen that the transmission and reception of a mesh node is always allocated in transmission bands opposite to those in which where the transmission and reception of a neighboring mesh node to the mesh node is allocated. For example, since the transmission of NODE 2 is allocated to transmission band B0 and the reception is allocated to transmission band B1, the transmission of mesh nodes NODE 1 and NODE 3 is allocated to transmission band B1 and the reception of NODE 1 and NODE 3 is allocated to transmission band B0. If the mesh nodes change places with each other, or other mesh nodes appear, then the transmission and reception of two neighboring mesh nodes is reallocated to different transmission bands.

In an embodiment, each mesh node is capable of simultaneously transmitting data to one or more neighboring mesh nodes in a first transmission band B0, and receiving data from one or more neighboring mesh nodes in a second transmission band B1. Further, each mesh node is capable of transmitting data simultaneously to one or more first neighboring mesh nodes in an uplink direction and to one or more second neighboring mesh nodes in a downlink direction in two or more subchannel regions of each transmission band B0, B1. The mesh nodes are also capable of receiving data simultaneously from one or more first neighboring mesh nodes from a downlink direction and from one or more second neighboring mesh nodes from an uplink direction in two or more subchannel regions of a transmission band B0 or B1.

In an embodiment, a mesh node can communicate with other mesh nodes about available resources that the mesh node may not need at the time. Then, this unused resource can be used by another mesh node. For example, if NODE 1 has nothing to transmit in T1.1 to NODE 0, then NODE 3 may use T1.1 transmission to NODE 2.

Dual carrier FDD is a practical mechanism to create 1/3 and also lower frequency reuses using two transmission bands. FIG. 4 clearly shows that interference always originates from at least three hop distances away, and never closer. For example, transmission T0.0/R0.0 of NODES 6 and 7 are in the same subchannel region 0 of the same transmission band B0. However, the nearest transmission in the same subchannel region is between NODES 3 and 4 (T0.0/R0.0), which is three hops away. Further, the directions of the transmissions are opposite, thus reducing the effect of interference. A mesh node can always have a 1/3 portion of the total used bandwidth (B0 and B1) allocated for transmission, and it can freely balance the downlink and uplink allocation within its allocated transmission spectrum, for instance based on traffic situation.

In an embodiment, time division duplexing (TDD) can be added on top of OFDMA so as to achieve a higher granularity allocating capacity for different users. The same principle can be applied to creating other (higher) frequency reuse factors.

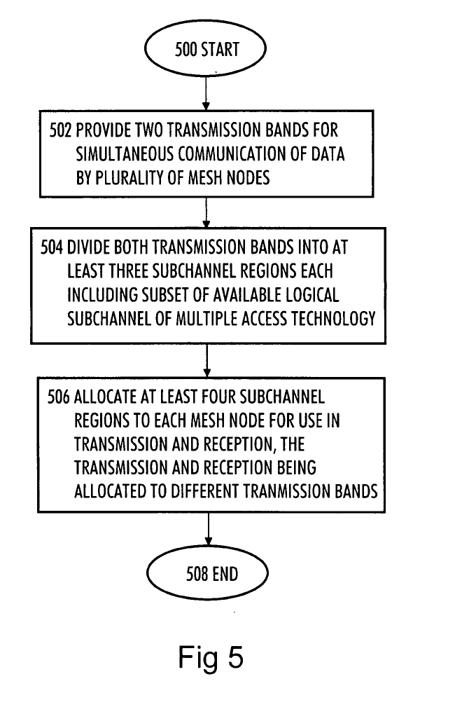

FIG. 5 illustrates an example of a method according to an embodiment of the invention. The method starts in 500. In 502, two transmission bands for simultaneous communication of signals by a plurality of mesh nodes of a mesh network are provided. In 504, both of the transmission bands are divided into at least three subchannel regions, each subchannel region including a subset of available logical subchannels of a multiple access technology. In 506, at least four subchannel regions of the transmission bands are allocated to each mesh node of the plurality of mesh nodes for use in transmission and reception, wherein the transmission and reception of a mesh node are allocated to subchannel regions of different transmission bands. The method ends in 508.

The embodiments of the invention may be realized in transceiver, comprising a controller. The controller may be configured to perform at least some of the steps described in connection with the flowchart of FIG. 5 and in connection with FIGS. 2 and 4. The embodiments may be implemented as a computer program comprising instructions for executing a computer process comprising: providing two transmission bands for simultaneous communication of signals by a plurality of mesh nodes of a mesh network; dividing both of the transmission bands into at least three subchannel regions, each subchannel region including a subset of available logical subchannels of a multiple access technology; and allocating at least four subchannel regions of the transmission bands to each mesh node of the plurality of mesh nodes for use in transmission and reception, wherein the transmission and reception of a mesh node are allocated to subchannel regions of different transmission bands.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A method comprising:
providing two transmission bands for simultaneous communication of signals by a plurality of mesh nodes of a mesh network;
dividing both of the transmission bands into at least three subchannel regions, each subchannel region including a subset of available logical subchannels of a multiple access technology; and
allocating at least four subchannel regions of the transmission bands to each mesh node of the plurality of mesh nodes for use in transmission and reception, wherein the transmission and reception of a mesh node are allocated to subchannel regions of different transmission bands.

2. The method of claim 1, further comprising: allocating the transmission and reception of the mesh node in transmission bands opposite to those to which where the transmission and reception of a neighboring mesh node to the mesh node is allocated.

3. The method of claim 1, further comprising: changing the allocations of transmission and reception of two neighboring mesh nodes to different transmission bands when the two neighboring mesh nodes change places.

4. The method of claim 1, further comprising: transmitting data to one or more neighboring mesh nodes in a first transmission band, and receiving data from one or more neighboring mesh nodes in a second transmission band.

5. The method of claim 1, further comprising: transmitting data simultaneously to one or more first neighboring mesh nodes in an uplink direction and to one or more second neighboring mesh nodes in a downlink direction in two or more subchannel regions of a transmission band.

6. The method of claim 1, further comprising: receiving data simultaneously from one or more first neighboring mesh nodes from a downlink direction and from one or more second neighboring mesh nodes from an uplink direction in two or more subchannel regions of a transmission band.

7. The method of claim 1, further comprising: balancing uplink and downlink communications within the allocated subchannel regions on the basis of traffic situation in the mesh network.

8. The method of claim 1, further comprising: applying time division multiplexing on top of orthogonal frequency division multiple access in the mesh network.

9. A mesh node comprising:
a processing unit configured to control functions of the mesh node; and
a transceiver configured to simultaneous communicate signals with one or more other mesh nodes of a mesh network using two transmission bands, wherein both of the two transmission bands include at least three subchannel regions, each subchannel region including a subset of available logical subchannels of a multiple access technology, wherein
the processing unit is configured to control use of at least four subchannel regions allocated to the mesh node for transmission and reception, wherein the transmission and reception of the mesh node are allocated to subchannel regions of different transmission bands.

10. The mesh node of claim 9, wherein the processing unit is configured to control the transmission and reception of the mesh node in transmission bands opposite to those to which where the transmission and reception of a neighboring mesh node to the mesh node is allocated.

11. The mesh node of claim 9, wherein the processing unit is configured to change the allocations of transmission and reception of the mesh node to different transmission bands when the mesh node changes places with a neighboring mesh node.

12. The mesh node of claim 9, wherein the processing unit is configured to transmit data to one or more neighboring mesh nodes in a first transmission band, and to receive data from one or more neighboring mesh nodes in a second transmission band.

13. The mesh node of claim 9, wherein the processing unit is configured to transmit data simultaneously to one or more first neighboring mesh nodes in an uplink direction and to one or more second neighboring mesh nodes in a downlink direction in two or more subchannel regions of a transmission band.

14. The mesh node of claim 9, wherein the processing unit is configured to receive data simultaneously from one or more first neighboring mesh nodes from a downlink direction and from one or more second neighboring mesh nodes from an uplink direction in two or more subchannel regions of a transmission band.

15. The mesh node of claim 9, wherein the processing unit is configured to balance uplink and downlink communications within the allocated subchannel regions on the basis of traffic situation in the mesh network.

16. A mesh network, comprising:
a plurality of mesh nodes, each mesh node comprising
a processing unit configured to control functions of the mesh node, and
a transceiver configured to simultaneous communicate signals with one or more other mesh nodes of a mesh network using two transmission bands, wherein both of the two transmission bands include at least three subchannel regions, each subchannel region including a subset of available logical subchannels of a multiple access technology, wherein
the processing unit is configured to control use of at least four subchannel regions allocated to the mesh node for transmission and reception, wherein the transmission and reception of the mesh node are allocated to subchannel regions of different transmission bands.

17. The mesh network of claim 16, wherein each of the plurality of mesh nodes is configured to control the transmission and reception of the mesh node in transmission bands opposite to those to which where the transmission and reception of a neighboring mesh node to the mesh node is allocated.

18. A transceiver for a mesh node, the transceiver comprising:
a transmitter configured to transmit signals in at least one subchannel region of at least three subchannel regions of a transmission band of two transmission bands allocated to a plurality of mesh nodes of a mesh network for simultaneous communication of signals, each subchannel region including a subset of available logical subchannels of a multiple access technology; and
a receiver configured to receive signals in at least one subchannel region of at least three subchannel regions of a transmission band of the two transmission bands other than that the transmitter is using for transmitting,
wherein the transceiver is configured to control use of at least four subchannel regions allocated to the mesh node for transmission and reception.

19. The transceiver of claim 18, wherein the transceiver is configured to control the transmission and reception of the mesh node in transmission bands opposite to those to which where the transmission and reception of a neighboring mesh node to the mesh node is allocated.

20. The transceiver of claim 18, wherein the transceiver is configured to change the allocations of transmission and reception of the mesh node to different transmission bands, when the mesh node changes places with a neighboring mesh node.

21. The transceiver of claim 18, wherein the transmitter is configured to transmit data to one or more neighboring mesh nodes in a first transmission band, and to receive data from one or more neighboring mesh nodes in a second transmission band.

22. The transceiver of claim 18, wherein the transmitter is configured to transmit data simultaneously to one or more first neighboring mesh nodes in an uplink direction and to one or more second neighboring mesh nodes in a downlink direction in two or more subchannel regions of a transmission band.

23. The transceiver of claim 18, wherein the receiver is configured to receive data simultaneously from one or more first neighboring mesh nodes from a downlink direction and from one or more second neighboring mesh nodes from an uplink direction in two or more subchannel regions of a transmission band.

24. The transceiver of claim 18, wherein the transceiver is configured to balance uplink and downlink communications within the allocated subchannel regions on the basis of traffic situation in the mesh network.

25. A computer-readable program distribution medium encoding a computer program of instructions for executing a computer process, the process comprising:
providing two transmission bands for simultaneous communication of signals by a plurality of mesh nodes of a mesh network;
dividing both of the transmission bands into at least three subchannel regions, each subchannel region including a subset of available logical subchannels of a multiple access technology; and
allocating at least four subchannel regions of the transmission bands to each mesh node of the plurality of mesh nodes for use in transmission and reception, wherein the transmission and reception of a mesh node are allocated to subchannel regions of different transmission bands.

26. The computer program distribution medium of claim 25, the distribution medium including at least one of the following media: a computer readable medium, a program storage medium, a record medium, a computer readable memory, a computer readable software distribution package, a computer readable signal, a computer readable telecommunications signal, and a computer readable compressed software package.

27. A mesh node comprising:
transceiver means for simultaneous communication of signals with one or more other mesh nodes of a mesh network using two transmission bands, wherein both of the two transmission bands include at least three subchannel regions, each subchannel region including a subset of available logical subchannels of a multiple access technology; and
processing means for controlling use of at least four subchannel regions allocated to the mesh node for transmission and reception, wherein the transmission and reception of the mesh node are allocated to subchannel regions of different transmission bands.

28. The mesh node of claim 27, wherein the processing means control the transmission and reception of the mesh node in transmission bands opposite to those to which where the transmission and reception of a neighboring mesh node to the mesh node is allocated.

29. A transceiver for a mesh node, the transceiver comprising:
transmitting means for transmitting signals in at least one subchannel region of at least three subchannel regions of a transmission band of two transmission bands allocated to a plurality of mesh nodes of a mesh network for simultaneous communication of signals, each subchannel region including a subset of available logical subchannels of a multiple access technology;
receiving means for receiving signals in at least one subchannel region of at least three subchannel regions of a transmission band of the two transmission bands other than that the transmitter is using for transmitting; and
processing means for controlling use of at least four subchannel regions allocated to the mesh node for transmission and reception.

30. The transceiver of claim 29, further comprising processing means for controlling the transmission and reception of the mesh node in transmission bands opposite to those to which where the transmission and reception of a neighboring mesh node to the mesh node is allocated.
